(19) United States
(12) Patent Application Publication
(10) Pub. No.: US 2010/0235045 A1
(43) Pub. Date: Sep. 16, 2010

(54) Virtual feature management for vehicle information and entertainment systems

(75) Inventors: Larry Vincent Craig, Plymouth, MI (US); Michael T. Burk, Peachtree City, GA (US)

Correspondence Address: PANASONIC AUTOMOTIVE SYSTEM;COMPANY OF AMERICA, 776 HWY 74 SOUTH, PEACHTREE CITY, GA, 30269, US

(73) Assignee: Panasonic Automotive Systems Company of America, Division of Panasonic Corporation of North America, Peachtree City, GA (US)

(21) Appl. No.: 12/381,291

(22) Filed: Mar. 10, 2009

(51) Int. Cl. G06F 19/00; G06F 15/16

(52) U.S. Cl. 701/36; 709/203

(57) ABSTRACT

Exemplary embodiments of the present invention relate to a mobile information display system that may be configured by a user to have customized interface screens and to display individualized content. For example, upon starting of the ignition system, the mobile information display system may access a remote server using a radio network interface to download interface screens that have previously been designed by a user. Further, the mobile information display system may download information and content from the remote server, or from other websites, including, for example, navigational information, destination information, calendar and alarm entries, e-mail messages, voice mail messages, personal networking pages, internet phone service, internet audio programs, and internet video programs, among others.

### FIELD OF THE INVENTION

The present invention generally relates to an information display system for a vehicle. More specifically, the present invention relates to a customizable system for accessing content from remote servers.

### BACKGROUND OF THE INVENTION

This section is intended to introduce the reader to various aspects of art which may be related to various aspects of the present invention which are described and/or claimed below. This discussion is believed to be helpful in providing the reader with background information to facilitate a better understanding of the various aspects of the present invention. Accordingly, it should be understood that these statements are to be read in this light, and not as admissions of prior art.

Vehicles, such as cars, trucks, SUVs, minivans, and boats, among others, are usually purchased with an in-vehicle information and entertainment system, or “infotainment” system that combines a fixed user interface with information sources located in the vehicle. For example, a mobile information system may have a connected CD player, satellite radio, and AM/FM radio connected to a central display panel. The central display panel may have a touch screen, associated buttons, or both, to allow each of these sources to be selected and played over an audio system that includes an amplifier and installed speakers. In some cases, a DVD player may be built into the vehicle to allow movies to be played. Further, an attached GPS unit may allow the system to determine the present location of the vehicle. In combination with map information that is generally provided on an optical disk in the vehicle, the GPS may provide navigation information to the operator. In many cases, the system will allow an operator to access display screens that provide controls for some of the vehicle parameters, such as the climate controls.

However, the configuration of the user interface for the systems described above is currently determined by the vehicle designers. Thus, if a driver does not like the user interface, their only choice is to not purchase the vehicle. Additionally, the information sources available to the vehicles are generally limited to the on-board sources, such as the CD/DVD players, map disk, and the like.

Other types of mobile systems, such as 3-G phones, may allow a large amount of general information to be obtained, but are not convenient for use in cars. For example, such phones have small screens that are generally not suitable for viewing by more than one person at a time and do not play DVDs or CDs. The phones are also not integrated with the accessories and controls in vehicles. Further, the controls are not particularly suited for use during driving. General purpose computing devices, such as laptops, may solve some of these problems, but are not integrated with the controls in vehicles, do not have user customizable control interfaces, and are difficult to operate while driving.

### SUMMARY OF THE INVENTION

An exemplary embodiment of the present invention provides a mobile information display system for a vehicle that includes a radio network interface and a user interface. The user interface includes two or more interface screens that may be selected to control access to content or vehicle controls, wherein the interface screens are customizable by accessing a service provider, and downloaded from the service provider over the radio network interface.

In other embodiments, the interface screens may be downloaded when selected by the user, while in other embodiments, the screens may be downloaded to the mobile information display system in a single access and stored in a memory. In this embodiment, the stored screens may be updated by new screens from the service provider. The mobile information display system may have a touch-screen for data entry, a global position system to determine vehicle position, or both. The mobile information display system may download content from the service provider as html encoded pages that may include

In other embodiments the mobile information system includes a primary network interface device and a secondary display system. The secondary display system includes a secondary display, and a secondary audio system, wherein the secondary audio system has a headphone jack for connecting an individual listening device to the secondary display. The secondary display also includes a secondary network interface device, which is configured to interface to the primary network interface device, and a secondary processor configured to obtain content from the mobile information display system through the secondary network interface device and render the content on the display screen, through the audio system, or both.

Another exemplary embodiment of the present invention provides a method for customizing a mobile information display system in a vehicle. The method includes accessing a service provider over a wide area network, making content selections on the service provider for content to be accessible by a mobile information display system in a vehicle, designing an appearance of an interface screen on the service provider for the mobile interface display system, and downloading the interface screen from the service provider to the mobile information display system.

In embodiments, accessing the service provider includes navigating to a website and providing appropriate credentials to access the configuration pages. Other embodiments include selecting content to be provided to the mobile information display system from the service provider, which may include creating links to files located on servers outside of the service provider, for example, to files located on a home or office server or to content provided by another service provider. Embodiments also provide for the design of interface screens, for example, by creating a list of content to appear in windows on the interface screen, creating a list of controls to appear on the interface screen, and locating the windows and the controls on the interface screen.

A third exemplary embodiment of the present invention provides a vehicle that includes an ignition system and a mobile information display system. The mobile information display system includes a display, a radio network interface, and a processor, wherein, when the ignition system is powered, the processor is configured to access a service provider over the radio network interface, download a user interface screen, and display the user interface screen on the display.

Another embodiment provides an internal network in the vehicle that is operatively coupled to the mobile information display system. A secondary display system may then be operatively coupled to the internal network. The secondary display system includes a display screen and a secondary audio system, wherein the secondary audio system comprises a headphone jack for connecting an individual listening device to the secondary display. The secondary display system also includes a secondary processor configured to obtain content from the mobile information display system through the internal network and render the content on the display screen, through the secondary audio system, or both.

### BRIEF DESCRIPTION OF THE DRAWINGS

The above-mentioned and other features and advantages of the present invention, and the manner of attaining them, will become apparent and be better understood by reference to the following description of one embodiment of the invention in conjunction with the accompanying drawings, wherein:

FIG. 1 is a drawing of a remote server at a service provider communicating with a vehicle over a radio network interface, in accordance with an exemplary embodiment;

FIG. 2 is a drawing of a mobile information display system, in accordance with an exemplary embodiment;

FIG. 3 is a process flow chart illustrating a method for programming a mobile information system over a remote server, in accordance with an exemplary embodiment;

FIG. 4 is a block diagram of the operation of a user interface that combines user designed elements with standard elements, in accordance with an exemplary embodiment;

FIG. 5 is a screenshot of a general interface screen for a mobile information display system, in accordance with an exemplary embodiment;

FIG. 6 is a screenshot of a user designed control screen, in accordance with an exemplary embodiment;

FIG. 7 is a screenshot of a interactive map screen, in accordance with an exemplary embodiment;

FIG. 8 is a screenshot of a destination information and entry screen, in accordance with an exemplary embodiment; and

FIG. 9 is a screenshot of secondary screen controls, in accordance with an exemplary embodiment.

Corresponding reference characters indicate corresponding parts throughout the several views. The exemplifications set out herein illustrate a preferred embodiment of the invention, in one form, and such exemplifications are not to be construed as limiting in any manner the scope of the invention.

### DETAILED DESCRIPTION OF THE PREFERRED EMBODIMENTS

One or more specific embodiments of the present invention will be described below. In an effort to provide a concise description of these embodiments, not all features of an actual implementation are described in the specification. It should be appreciated that in the development of any such actual implementation, as in any engineering or design project, numerous implementation-specific decisions may be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

Exemplary embodiments of the present invention relate to a mobile information display system that may be configured by a user to have customized interface screens and to display individualized content. For example, upon starting of the ignition system of a vehicle, the mobile information display system may access a remote server at a service provider using a radio network interface to download interface screens that have previously been designed by a user. Further, the mobile information display system may download information and content from the server provider, or from other sites, including, for example, navigational information, destination information, calendar and alarm entries, e-mail messages, voice mail messages, personal networking pages, internet phone service, internet audio programs, and internet video programs, among others.

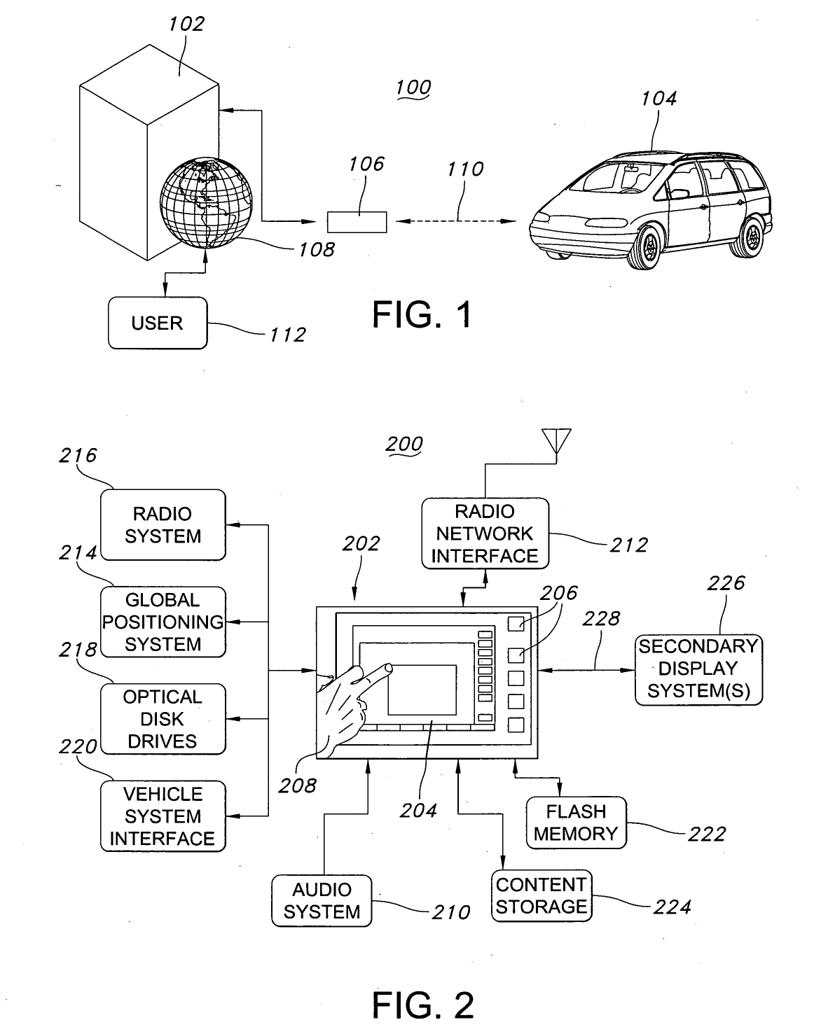

FIG. 1 is a drawing of a system 100 in which a service provider 102 communicates with a mobile information display system in a vehicle 104 over a mobile radio network 106, such as a mobile phone network, in accordance with an exemplary embodiment of the present invention. The service provider 102 may have access to internet sites located on the world-wide web 108. A radio network interface in the vehicle 104 may communicate with the mobile radio network 106 over a radio link 110. For example, the vehicle 104 may inform the service provider 102 that it is ready to download an interface screen to the mobile information display system. The interface screen may have been previously designed by a user 112 who may have logged into the service provider 102 over the world-wide web 108. Further, the vehicle 104 may request content to be pushed from the service provider 102 to the mobile information display system in the vehicle 104.

FIG. 2 is a drawing of a mobile information display system, or MIDS, 200, in accordance with an exemplary embodiment of the present invention. As illustrated in FIG. 2, the system 200 has a user interface 202 that may include a display screen 204 and controls 206 that a user 208 may activate to select information or entertainment sources. In an exemplary embodiment, the display screen 204 may comprise a touch activated display, e.g., a touch screen. The MIDS 200 may also have an audio system 210 that uses an amplifier to drive speakers located in the cabin of the vehicle.

The MIDS 200 will have a radio network interface 212 to communicate with the mobile radio network. Further, the MIDS 200 may include a number of other systems to enhance operability. Such systems may include a global position system, or GPS, 214 for use by a navigation program in determining the vehicle location and mapping routes to destination. The MIDS 200 may also include a radio system 216 that may include AM, FM, and satellite radio systems. The use of information accessed over the radio network interface 212 does not preclude the use of onboard information and entertainment systems. For example, the MIDS 200 may include one or more optical drives 218 to access information such as navigational maps, music CDs, DVDs, or writable CD drives, e.g., for downloading and storing program information. Such local storage may enhance the use of the MIDS 200 in areas where signal accessibility may be intermittent, such as in mountainous regions. The MIDS 200 may also include a vehicle systems interface 220 to access and control various vehicle systems, such as the climate controls, window defrosting controls, and engine information displays, among others.

The MIDS 200 may have a screen memory to store information for the current user interface screen, with the user interface existing outside of the MIDS 200. For example, the user interface may exist, wholly or partially, on the computers of the service provider. In this embodiment, for example, the MIDS 200 may be functioning as a web browser, with content downloaded from the remote server in the form of pages that have content encoded in html, xml, java, pearl, or other browser coding schemes.

In another embodiment, the MIDS 200 may have a flash memory 222 to store the current user interface. This enables the MIDS 200 to be operational even if the radio network interface 212 is unable to communicate with the mobile radio network. The user interface configuration in the flash memory 222 may be updated over the radio network interface 212 or may be accessible to allow removal, reprogramming, and replacement. The MIDS 200 may also have other memory units, such as the optical disk drives 218 or a separate content storage unit 224. The content storage unit 224 may include flash memory units or hard drives, among others. The content storage unit 224 may be used to store content downloaded from the service provider or from other content providers, such as websites.

The MIDS 200 will have a processor configured to obtain content from a remote server over the radio network interface 212 and render the content on the display screen 204, through the audio system 210, or both. Further, the processor may coordinate the operation of the units described above. For example, the processor may obtain a map from a service provider or web site, obtain a current location for the vehicle from the GPS system, and render a navigation screen that displays the location of the vehicle on the map. In another example, the processor may access content from a service provider, store the content in the content storage 224 and render the content through the display 204, the audio system 210, or both, at a later point in time. As a third example, the processor may render a control screen on the display 204 allowing the user to make an operational change to a vehicle system, such as selecting a temperature setting for the environmental controls. Further examples of operations that may be controlled by the processor are discussed with respect to FIGS. 4-9. It should be understood that the operations of the system are not limited to these examples. Indeed, the MIDS 200 may perform any number of tasks programmed by the user or vehicle designer.

The display screen 204 of the user interface 202 does not have to be the only point for information display. In exemplary embodiments of the present invention, one or more secondary displays 226 may be coupled to the MIDS 200 through a network 228. The network 228 may be based on any number of network technologies. For example, a universal serial bus, or USB, may be used to carry Ethernet packets containing TCP/IP encoded data between the MIDS 200 and the secondary displays 226. In this configuration, the MIDS 200 would act as an in-vehicle server, downloading information from the remote server 102, or other sites, and providing that information in the form of html encoded pages to the secondary display systems 226.

The secondary screens 226 may include a processor to render visual content from the MIDS 200 on a display screen and an audio system to play audio content, either separately from the displayed content or as part of a video program. The audio system of the secondary display systems 226 may have a headphone jack to allow content to play without interfering with content playing on the MIDS 200 or on any other of the secondary display systems 226. Controls for the secondary display systems 226 may be built into the display, such as controls along the edge of the display or the use of a touch screen. Alternately, the controls for the secondary display systems 226 may be mounted into a proximate structure, such as a center console or an armrest, to allow ease of access.

Using the MIDS 200 as a central server to provide content to the secondary screens 226 allows passengers to have individual entertainment programs operational on separate screens. Further, the secondary display screens 226 may be configured to allow users to request the content from the service provider, without the need for the vehicle operator to intervene. This may lower the complexity of the operation of the MIDS 200 for the operator of the vehicle, e.g., the driver or captain.

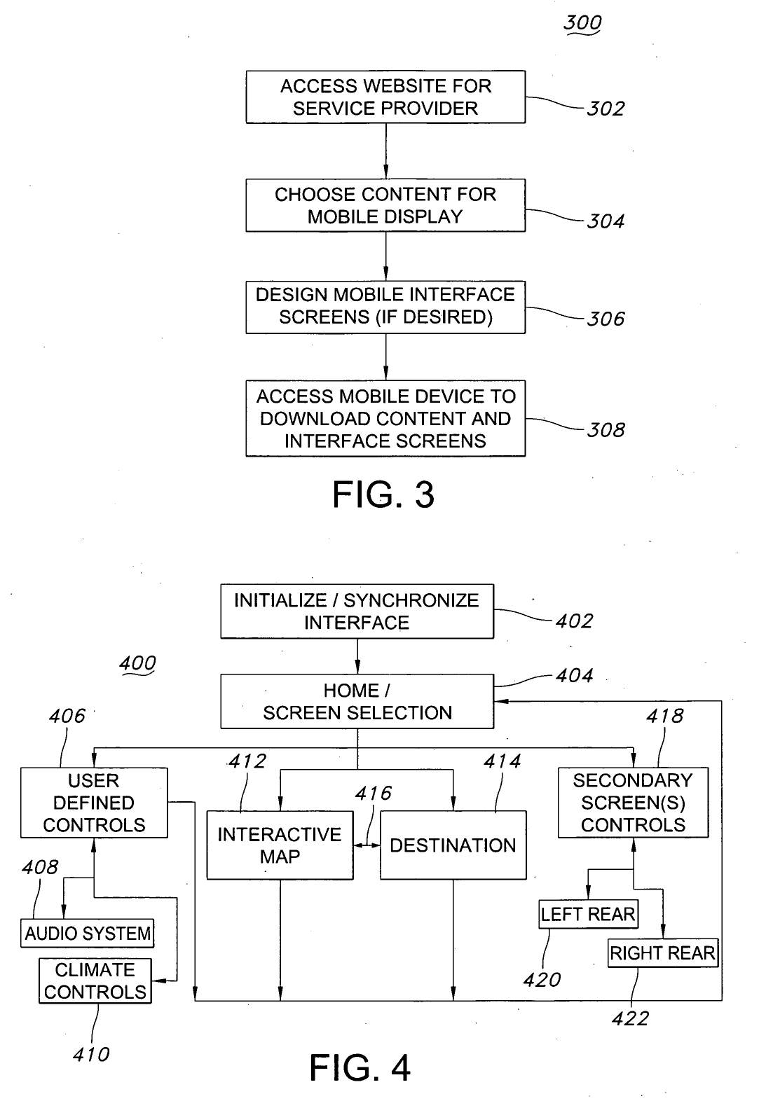

FIG. 3 is a process flow chart illustrating a method 300 for programming a mobile information system over a remote server, in accordance with an exemplary embodiment. The method 300 begins in block 302 when a user accesses a website for the service provider. The user may be required to enter substantially secure credentials to prevent unauthorized persons from accessing the website and changing the user interface for the vehicle.

The method 300 continues with the user making selections of the content that will be accessible to the MIDS. As discussed herein, such content may include navigational information, destination information, calendar and alarm entries, e-mail messages, voice mail messages, personal networking pages, internet phone service, internet audio programs, satellite radio services, video-on-demand services, and internet video programs, among others.

The user may choose to accept standard configuration screens offered by the service provider for the content selections chosen. Alternatively, the user may wish to design interface screens that more specifically match the user's desires, as indicated in block 306. Other choices may be made to customize the look and feel of the interface screen, such as appearance themes, or skins, fonts, colors, and links between screens.

The final step in the process is to access the MIDS to download the interface screens from the service provider. If the MIDS is only acting as a web terminal, the screens are downloaded to the MIDS when a particular screen is requested. If the MIDS contains a flash memory to store a user interface, the user interface, including all interface screens and available content choices, may be downloaded in a single access to the MIDS, as indicated in block 308. The downloading may generally be carried out by powering the vehicle, such as activating the ignition system, as discussed further with respect to FIG. 4.

FIG. 4 is a block diagram of the operation 400 of a user interface for the MIDS that combines user designed elements with standard elements, in accordance with an exemplary embodiment. This figure should be considered as merely one example of a user interface configuration. It should be understood that any number of configurations may be used, limited only be the imagination of the user. The operation 400 begins in block 402 with the initialization of the MIDS and the downloading of the interface screens from the service provider. Generally, the initialization and downloading step takes place automatically when the ignition system of the vehicle is turned on. However, a manual procedure, such as a particular button combination, may be provided if the user did not have access to the mobile radio network at the time the vehicle was started.

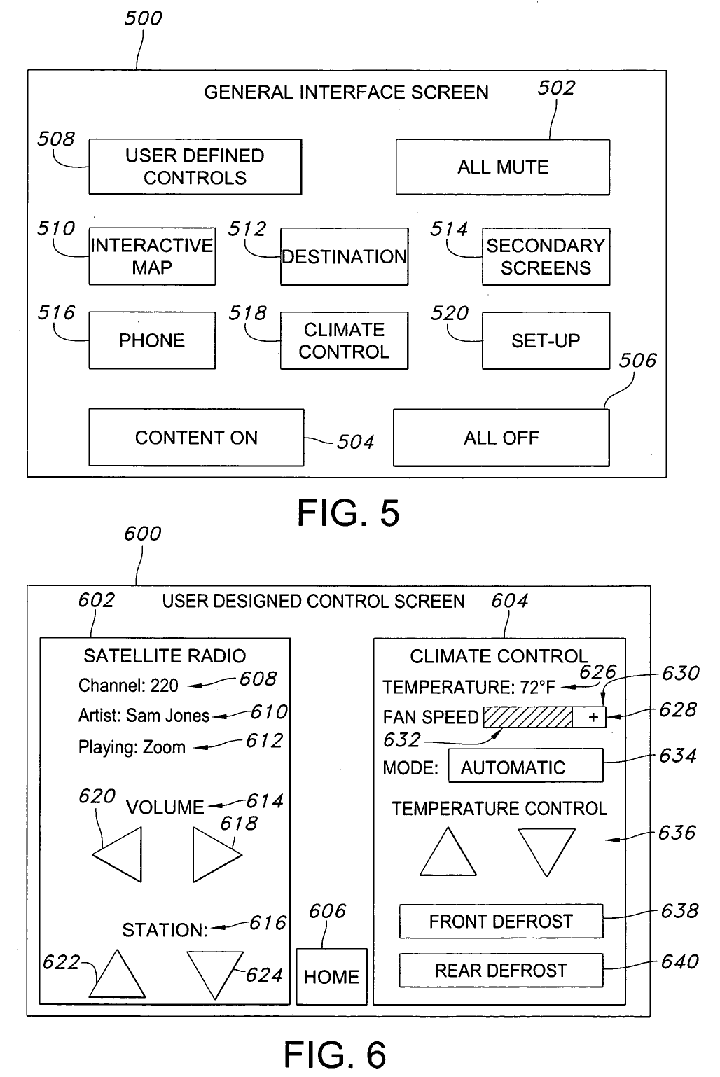

After initialization, in block 404, the MIDS may display a general interface screen that allows the user to select information, content, or control screens. As discussed herein, the screens may be downloaded from a service provider when requested, or in embodiments using a flash memory, the screens may be stored in the flash memory to await selection. Examples of such screens are discussed with respect to FIGS. 5-9. From the general interface screen, a user may select any number of auxiliary screens for particular options. Such screens may include, for example, screens containing user designed controls, as indicated in block 406. Each of the screens may include sub-screens that have controls for various functions. For example, the user defined control screen in block 406 may have sub-screens containing controls for the audio system, as indicated in block 408 or the environmental system, as indicated in block 410.

Other screens that may be accessed from a general interface screen may include an interactive map, as indicated in block 412 and a destination screen, as indicated in block 414. The map and destination screens may be directly accessible from each other, as indicated by line 416. This may allow, for example, a user to enter a destination then return to an interactive map to see an interactive map showing the route to the destination. In another example, the destination screen may be selected from the interactive map to display information on the current location.

If secondary screens are networked to the MIDS, a specific control screen for the secondary screens may be accessible from the general interface screen, as indicated in block 418. This screen may have sub-screens that contain controls for each of the individual secondary screens networked, as indicated in blocks 420 and 422. These controls may be in addition to control screens that may be displayed on the secondary screens themselves.

FIG. 5 is a screenshot of a general interface screen 500 for a MIDS, in accordance with an exemplary embodiment of the present invention. The general interface screen may contain a number of buttons that correspond to controls or sub-screens that may be selected. The general interface screen 500 may be a standard screen designed by the manufacturer or, as illustrated in FIG. 5, may be designed by a user. An individual button may be selected by directly pressing the screen over the button, for example, if the screen is touch sensitive. Alternatively, the button may be selected using physical controls, such as a rotary knob that sequentially highlights each button as it is turned, followed by pressing a selection button to enter the choice. Any number of other interface schemes to select items on a visual display may be used herein, including pointing devices, arrow keys, and the like.

The buttons on the general interface screen 500 may include various general control buttons, such as a mute button 502 that silences the audio programs, for example, from the speakers. Another general control button that may be included in exemplary embodiments allows a user to turn content on 504, allowing access to audio, video, or web based content. The access to content may be ended by selecting an off button 506, which may be configured to terminate content only on the MIDS, or on all displays networked to the MIDS.

The general interface screen 500 may also include buttons configured to switch from the general interface screen 500 to other interface screens. For example, the general interface screen 500 may include a button to switch to a screen displaying user defined controls 508. An example of the content that may be display on such a screen is discussed further with respect to FIG. 6. The interface is not limited to a single user defined screen, as any number of user screens may be generated and linked to buttons on the general interface screen 500. For example, there may be 5, 10, 15, or more user defined screens, which may be accessed from either the general interface screen 500 or from each other, for example, in a hierarchical configuration.

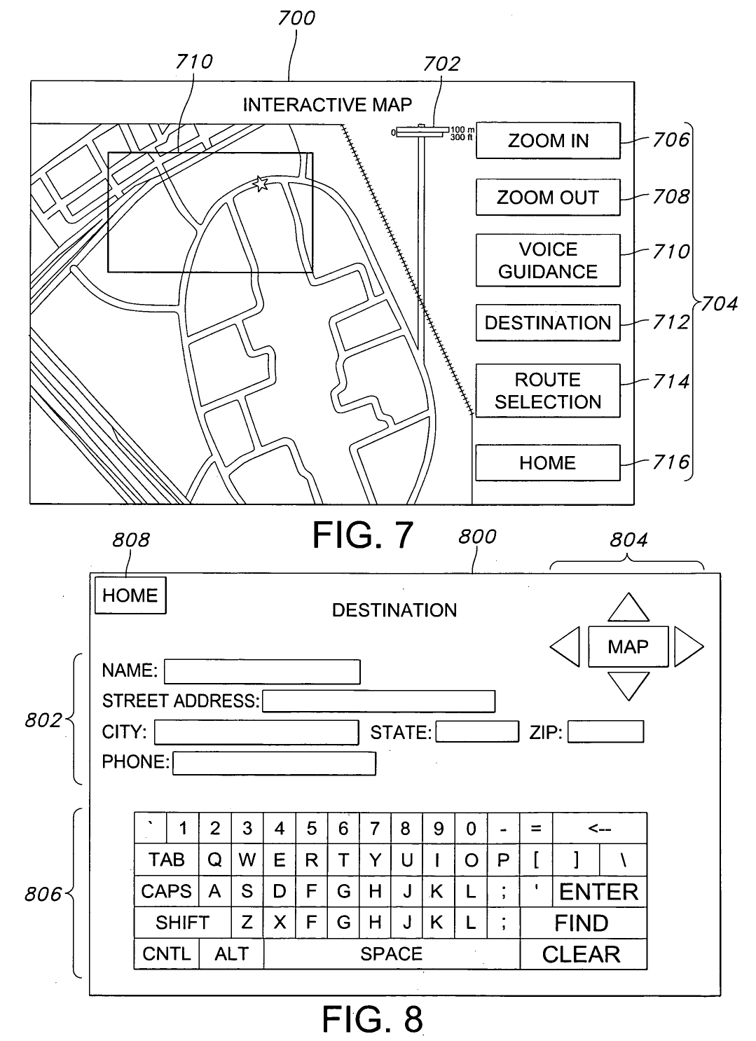

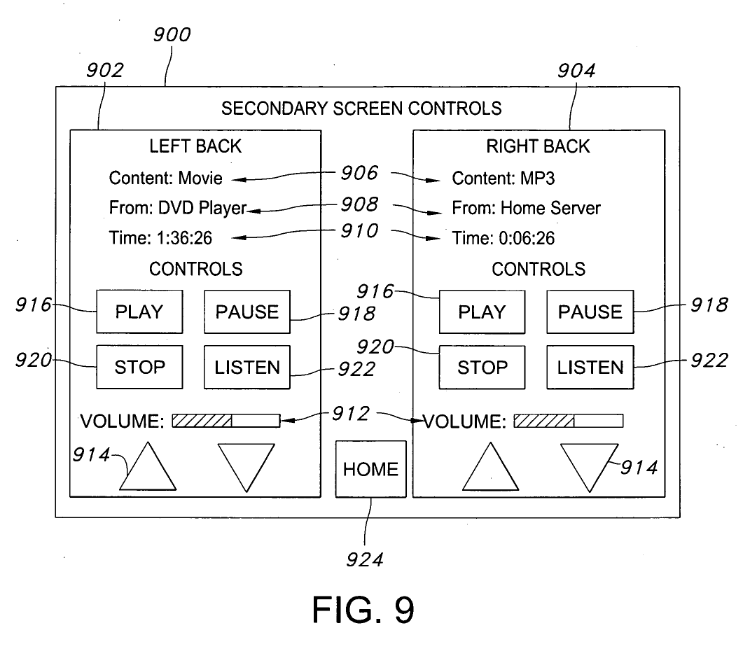

The general interface screen 500 may also include a button 510 configured to access an interactive map, as discussed further with reference to FIG. 7. Another button 512 may be configured to access a screen for setting a destination, as discussed further in reference to FIG. 8. If secondary screens are networked to the MIDS, another button 514 may access controls for the secondary screens, as discussed with reference to FIG. 9.

The general interface screen 500 may also contain buttons leading to control screens that have been designed by the vehicle manufacturer. For example, the general interface screen 500 may contain a button 516 leading to a screen that allows a user to originate or answer telephone calls from the vehicle. Other buttons may allow access to previously designed screens for the climate controls 518, or to set-up 520 the system, e.g., to set the language, clock, navigational controls, and the like.

FIG. 6 is a screenshot of a user designed control screen 600, in accordance with an exemplary embodiment. In the illustrated embodiment, the user designed control screen 600 has two sub-screens that provide controls for a satellite radio 602 and climate control system 604. A separate button 606 may be placed on the user designed control screen 600 to return the general interface screen 500 to the display. The user designed control screens are not limited to the screen shown, as the user may create any number of control configurations in various arrangements and appearances.

The user designed control screen 600 may provide both information on the current status of the system and control over the system. For example, the satellite radio sub-screen 602 may show the current channel 608, and display information provided from the satellite downlink, such as the performing artist 610 and name 612 of the current song. Controls may be placed on the sub-screen 602 to adjust the volume 614 and station 616. Such controls may, for example, use intuitive graphical shapes to indicate raising 618 or lowering 620 the volume, or increasing 622 or decreasing 624 the channel.

The climate control sub-screen 604 may show the current temperature 626 in the vehicle. Another control may show the speed 628 of the blower as well as provide control over the blower speed. For example, a user may press one end of the fan speed indicator bar 628 to raise the blower speed, e.g., at the plus 630, or press the other end to lower the blower speed, e.g., at the minus sign 632. Other controls may be placed on the climate control sub-screen 604 to control functions such as the operational mode 634 of the climate control system, the temperature 636, a front defroster 638, and a rear defroster 640.

FIG. 7 is a screenshot of an interactive map screen 700, in accordance with an exemplary embodiment. The map screen 700 may be designed by the manufacturer and may be used with or without modification by a user. Alternatively, a user may design a personal map screen. In either case, the map information may be pulled from a mapping web site, such as mapquest.com or maps.google.com. Alternatively, the mapping information may reside on an optical disk within the MIDS. In this case, the processor may be configured to automatically update the information on a regular basis, such as daily, weekly, or monthly.

Generally, the interactive map screen 700 will display a map 702 and may display a series of controls 704. The controls 704 may be continuously visible or only display under certain conditions, such as when the user touches the display. The controls may include, for example, buttons for zooming in 706 or zooming out 708 the map 702. Alternatively, magnification changes may be controlled by other means, such as drawing a box 710 around an area of interest with a fingertip, after which the map 702 displays the area in the box 710 over the full display. Other controls that may be provided on the interactive map screen 700 include, for example, buttons for initiating voice guidance 712, displaying a destination entry screen 712, controlling the selection of a route 714, or for returning to the general interface screen, as indicated by button 716.

FIG. 8 is a screenshot of a destination information and entry screen 800, in accordance with an exemplary embodiment of the present invention. The destination screen 800 may be configured to provide multiple functions. For example, the destination screen 800 may allow for the entry of information concerning a desired destination, which may then be used by the navigation system to build a route to the destination. The route may then be displayed and charted on the map screen 700. Alternatively, the destination screen 800 may be used as a tool to look up information on a subject using known information, such as a name or address, to determine unknown information, such as a phone number. In contrast to a static database on an optical disk, the use of the radio network interface by the MIDS to access the information through a service provider may help to ensure that the information is current.

The destination screen 800 may have a number of buttons to assist in information entry and retrieval. For example, a series of fields 802 may allow the entry of information about a destination, such as the name and address. Navigation buttons 804 may be included for conveniently moving between fields and for displaying the map screen 700. A keypad 806 may be displayed on the destination screen 800 for the entry of data into the fields 802. Further, a button 808 may be included to return the display to the general interface screen 500.

If secondary displays are networked with the MIDS, a user may wish to create control screens that provide monitoring and control of the secondary display screens from the MIDS display. FIG. 9 is a screenshot of a secondary screen control display 900, in accordance with an exemplary embodiment. In the illustrated embodiment, two secondary screens, a left rear display and a right rear display, are networked with the MIDS. However, the MIDS is not limited to two secondary screens, and more or less screens may be networked. For example, in other embodiments, only one secondary screen may be networked to the MIDS, while in other embodiments two, three, four, or even more secondary screens may be networked to the MIDS.

In the embodiment illustrated in FIG. 9, the secondary screen control display 900 has a sub-screen corresponding to each of the networked screens. A left back sub-screen 902 may control one of the secondary displays, while a right back sub-screen 904 may control another secondary display. Each of the secondary display sub-screens may display information showing the type of content displayed 906, the source of the content 908, and the time that the program has played 910. Further, each sub-screen may show the present volume 912 of the respective audio systems.

Further controls may be included to enable the user of the MIDS to control the content and play on each of the secondary displays. Such controls may include volume buttons 914, for example, to lower a volume if the operator determines that one of the users of the secondary displays may have the volume set too high. Other controls may include buttons to play 916, pause 918, or stop 920 playing of content on the secondary screens. As illustrated, the user may decide to include a listen button 922 to allow the content on the secondary screen for which it is selected to be played through the main speakers of the MIDS. As for the other screens, a button 924, may be included on the secondary screen controls 900 to return the display to the general interface screen 500.

While the invention may be susceptible to various modifications and alternative forms, specific embodiments have been shown by way of example in the drawings and will be described in detail herein. However, it should be understood that the invention is not intended to be limited to the particular forms disclosed. Rather, the invention is to cover all modifications, equivalents and alternatives falling within the spirit and scope of the invention as defined by the following appended claims.

What is claimed is:

1. A mobile information display system for a vehicle, comprising:
a radio network interface;
a user interface comprising two or more interface screens that may be selected to control access to content or vehicle controls, wherein the interface screens are:
customizable by accessing a service provider; and
downloaded from the service provider over the radio network interface.

2. The mobile information display system of claim 1, wherein the interface screens are downloaded from the service provider when selected by a user.

3. The mobile information display system of claim 1, comprising a flash memory to store the interface screens downloaded from the service provider.

4. The mobile information display system of claim 3, wherein the interface screens stored in the flash memory are updated with new interface screens over the radio network interface.

5. The mobile information display system of claim 1, comprising a touch-screen display.

6. The mobile information display system of claim 1, comprising a global positioning system receiver.

7. The mobile information display system of claim 1, comprising
an audio system, comprising:
an amplifier; and
speakers, wherein the speakers are powered by the amplifier; and
a processor configured to obtain content from the service provider over the radio network interface and render the content on the display screen, through the audio system, or both.

8. The mobile information display system of claim 7, wherein the content comprises html encoded pages received from the service provider over the radio network interface.

9. The mobile information display system of claim 7, wherein the content comprises navigational information, destination information, calendar and alarm entries, e-mail messages, voice mail messages, personal networking pages, internet phone service, internet audio programs, internet video programs, or both.

10. The mobile information display system of claim 7, wherein the content is downloaded into a memory in the mobile information system for later playback.

11. The mobile information display system of claim 1, comprising:
a primary network interface device; and
a secondary display system, comprising:
a secondary display;
a secondary audio system, wherein the secondary audio system comprises a headphone jack for connecting an individual listening device to the secondary display;
a secondary network interface device, wherein the secondary network interface device is configured to interface to the primary network interface device; and
a secondary processor configured to obtain content from the mobile information display system through the secondary network interface device and render the content on the display screen, through the audio system, or both.

12. The mobile information display system of claim 11, wherein the content provided to the secondary display system by the mobile information system is obtained through the radio network interface.

13. The mobile information display system of claim 11, wherein the secondary display is a touch-screen display.

14. The mobile information display system of claim 11, comprising armrest mounted controls.

15. A method for customizing a mobile information display system in a vehicle, comprising:
accessing a service provider over a wide area network;
making content selections on the service provider for content to be accessible by a mobile information display system in a vehicle;
designing an appearance of an interface screen on the service provider for the mobile interface display system; and
downloading the interface screen from the service provider to the mobile information display system.

16. The method of claim 15, wherein accessing a service provider over a wide area network comprises:
accessing a website for the service provider from a computer system over an internet connection; and
entering identification information to access configuration files for the mobile information display system.

17. The method of claim 15, wherein making content selections comprises creating a list of web sites that can be accessed from the mobile information display system.

18. The method of claim 15, wherein making content selections comprises creating access links to files located on a server outside of the service provider.

19. The method of claim 15, wherein making content selections comprises subscribing to content providers for audio programs, video programs, or both to be accessed from the mobile information display system.

20. The method of claim 15, wherein designing an appearance of an interface screen comprises:
creating a list of content to appear in windows on the interface screen;
creating a list of controls to appear on the interface screen; and
locating the windows and the controls on the interface screen.

21. A vehicle comprising:
an ignition system; and
a mobile information display system, comprising:
a display;
a radio network interface;
a processor, wherein when the ignition system is powered, the processor is configured to access a service provider over the radio network interface, download a user interface screen, and display the user interface screen on the display.

22. The vehicle of claim 21, comprising:
an internal network, wherein the internal network is operatively coupled to the mobile information display system; and
a secondary display system operatively coupled to the internal network, comprising:
a display screen;
a secondary audio system, wherein the secondary audio system comprises a headphone jack for connecting an individual listening device to the secondary display;
a secondary processor configured to obtain content from the mobile information display system through the internal network and render the content on the display screen, through the secondary audio system, or both.
